(19) United States
(12) Patent Application Publication
(10) Pub. No.: US 2012/0256868 A1
(43) Pub. Date: Oct. 11, 2012

(54) APPARATUS FOR SENSING A TOUCH

(76) Inventors: Yun Young CHOI, Seoul (KR); Sang Hyub/Kang, Namyangju-si (KR); Jin Seok/Koh, Seongnam-si (KR); Jong Hwa/Lee, Yongin-si (KR)

(21) Appl. No.: 13/204,252

(22) Filed: Aug. 5, 2011

(30) Foreign Application Priority Data
Apr. 11, 2011 (KR) 10-2011-0033263

(51) Int. Cl. G06F 3/045

(52) U.S. Cl. 345/174

(57) ABSTRACT

An apparatus for sensing a touch which can determine a touch and touch sensitivity thereof in a capacitance-type touch panel. The apparatus for sensing a touch includes a first amplifier having first and second input terminals for outputting a difference of a first input voltage being applied to the first input terminal and a second input voltage being applied to the second input terminal, a second amplifier for amplifying and outputting the difference from the first amplifier, a converting unit for converting an output from the second amplifier into a digital signal and outputting the digital signal, and a control unit for interpreting an output from the converting unit to output a control signal for adjusting impedance of the second input terminal. The control unit stores the output from the converting unit as an error code in a calibration mode, and the control unit detects a change of a voltage applied to the first input terminal from a result of comparison of the output from the converting unit with reference to the error code stored thus in a scan mode.

### CROSS REFERENCE TO RELATED APPLICATION

The present application claims priority under 35 U.S.C. §119 to Korean Patent Application No. 10-2011-0033263 (filed on Apr. 11, 2011), which is hereby incorporated by reference in its entirety.

### BACKGROUND

A touch screen sensor has a transparent conductive film coupled to a display device. Touch screen sensing is sensing of a change of resistance or capacitance at the time a body or a particular thing touches, or comes into close proximity of, the touch panel. Particularly, a capacitance-type touch screen sensor is a sensor for sensing minute capacitance of the body or the particular thing, in which a touch is sensed by sensing a minute change of resistance or capacitance at the time the body or the particular thing touches, or comes into close proximity of, the touch panel. For example, the capacitance-type touch screen sensor senses a difference between a minute change of capacitance taken place at the time the thing having capacitance comes into proximity of, or touches, the sensor and a preset value, and forwards a high or low pulse finally, to sense a touch by means of an output pulse.

In capacitance-type sensors, there are mutual capacitance sensors, and self capacitance sensors. As one example of the self capacitance sensor, the self capacitance sensor has X-Y electrodes and a column array and a row array operatively independent from each other and identical to the mutual capacitance sensor.

There have been ceaseless development of technologies regarding capacitance sensors. Even now, capacitance sensor designers are maintaining research for enhancing functions and affectivity of the sensors. Particularly, capacitance sensor designers focus on a low design cost and simplification of sensor designs, basically putting effort in the development of technologies for providing accurate capacitance sensing together with the aforementioned requirements.

### SUMMARY

Embodiments are related to touch panels, and more particularly to an apparatus for sensing a touch which can determine a touch and touch sensitivity thereof in a capacitance-type touch panel.

Embodiments are related to an apparatus for sensing a touch.

Embodiments are related to an apparatus for sensing a touch, which is configured to provide more accurate capacitance sensing for a capacitance-type sensor which enhances touch sensitivity of a touch panel.

In accordance with embodiments, an apparatus for sensing a touch includes at least one of the following: a first amplifier having first and second input terminals configured to output a difference of a first input voltage applied to the first input terminal and a second input voltage applied to the second input terminal, a second amplifier configured to amplify and output the difference from the first amplifier, a converting unit configured to convert the output from the second amplifier into a digital signal and output the digital signal, and a control unit configured to interpret the output from the converting unit to output a control signal which adjusts impedance of the second input terminal. The control unit is also configured to store the output from the converting unit as an error code in a calibration mode, and also detect a change of a voltage applied to the first input terminal from a result of comparison of the output from the converting unit with reference to the error code stored thus in a scan mode.

It is to be understood that both the foregoing general description and the following detailed description of the present invention are exemplary and explanatory and are intended to provide further explanation of the invention as claimed.

### DRAWINGS

The above and other features of the invention will become apparent from the following description of embodiments given in conjunction with the accompanying drawings, in which:

Example FIG. 1 illustrates a block diagram of a capacitance-type touch sensing apparatus in accordance with embodiments.

FIG. 2 illustrates a block diagram of a capacitance-type touch sensing apparatus in accordance with embodiments.

FIG. 3 illustrates a circuit diagram of a capacitance-type touch sensing apparatus in accordance with embodiments.

### DESCRIPTION

Reference will now be made in detail to the specific embodiments of the invention, examples of which are illustrated in the accompanying drawings. Wherever possible, the same reference numbers will be used throughout the drawings to refer to the same or like parts. Configuration and operation of embodiments the invention illustrate in drawings attached hereto and described with reference to the drawings is described as at least one embodiment of the invention. Technical aspects and essential configuration and operation of embodiments, however, are not limited by the description.

Embodiments of the invention is provided to embody a capacitance-type sensing apparatus, and more particularly, to a capacitance-type sensing apparatus which is operative in a calibration mode in which impedance of one of two input terminals is calibrated for making voltages of the two input terminals the same, or minimizing a difference of the voltages of the two input terminals at the time no touch of a body or a particular thing is taken place to a touch panel, and in a scan mode in which the apparatus scans a touch of a body or a particular thing to the touch panel or touch sensitivity thereof after the calibration mode.

Example FIG. 1 illustrates a block diagram of a capacitance-type touch sensing apparatus in accordance with embodiments.

As illustrated in example FIG. 1, the capacitance-type touch sensing apparatus includes a touch panel 10, a difference detector 20, a control unit 30, and a calibration circuit 40. The capacitance-type touch sensing apparatus may further include a feedback routine 50 for providing a control signal to the calibration circuit 40 from the control unit 30.

The difference detector 20 detects a difference of two input voltages. The difference detector 20 has two inputs: one of which is an output terminal of the touch panel 10, and the other an output terminal of the calibration circuit 40. Particularly, the first input terminal is an output terminal of one channel of the touch panel 10.

In the calibration mode, the control unit 30 forwards a control signal to the calibration circuit 40 with reference to an output from the difference detector 20. The control unit 30 outputs the control signal through the feedback routine 50, and the control signal is a feedback signal provided through the feedback routine 50.

The touch panel 10 has a plurality of channels, and the control unit 30 has error codes stored therein for calibration of the channels. In this instance, the error codes are outputs from the difference detector 20 which are digital codes on the difference of the two input voltages in the calibration mode. In order to store the error codes of a respective channel, the control unit 30 connects an apparatus in accordance with embodiments of the invention to the channels in sequence to store the digital codes which are the outputs of the difference detector 20 therein. In this instance, the apparatus in accordance with embodiments of the invention can be provided with a multiplexer (MUX) for sequential connection to the channels. Each of the channels of the touch panel 10 is provided with a capacitor driven by a supply voltage Vref and can include a resistor Rito which is equivalent to a parasitic component.

In this instance, the capacitor has a charge charged therein by the supply voltage. An output voltage coming from discharge of the capacitor is one of the two input voltages to the difference detector 20. The calibration circuit 40 is a RC network having resistors Rin and capacitors Cc driven by a supply voltage Vref supplied to the touch panel 10, in common. The capacitor Cc has a charge charged therein by the supply voltage. An output voltage coming from discharge of charge from the capacitor is the other one of the input voltages to the difference detector 20.

At the time of the calibration mode, the calibration circuit 40 changes at least one of the capacitor Cc and the resistor Rin to change the impedance. In order to change the impedance, the calibration circuit 40 has a structure for changing at least one of the capacitance and resistance. For an example, the calibration circuit 40 can have a variable capacitor and a fixed resistor. Alternatively or in combination, the calibration circuit 40 can have a variable capacitor and a variable resistor. Alternatively or in combination, the calibration circuit 40 can have a fixed capacitor and a variable resistor.

The calibration circuit 40 applies a voltage of the impedance changed thus under the control of the control unit 30 to the difference detector 20. The difference detector 20 uses a voltage applied thereto from the calibration circuit 40 after the calibration mode as a reference voltage in the scan mode. That is, in the scan mode, the control unit 30 determines whether a touch to the touch panel 10 is made or not and touch sensitivity by using a difference between the reference voltage and the voltage applied from the touch panel 10. In other words, the control unit 30 determines that the touch is made if there is a difference between the reference voltage and the voltage applied thereto from the touch panel 10, and determines the touch sensitivity with reference to magnitude of the difference.

The difference detector 20 detects a difference of one input voltage from the touch panel 10 and another input voltage from the calibration circuit 40. The difference detector 20 amplifies the difference detected, converts the amplified value to a digital signal, and forwards the digital signal. For an example, the difference detector 20 outputs a two bit length of digital signal, and the control unit 30 outputs the control signal to the feedback routine 50 for increasing or decreasing the impedance of the calibration circuit 40 according to the digital signal.

In the calibration mode, the impedance of the calibration circuit 40 is calibrated for removing an error liable to cause by the capacitance at the touch panel 10 even if no touch is made to the touch panel 10, or an offset liable to cause by an external environment. Moreover, in the scan mode, whether the touch is made or not and the touch sensitivity is determined using the difference having the error detected in the calibration mode removed therefrom. The difference can be expressed by Equation 1 hereinbelow.

$$Δ V = Vref ( {e}^{- \frac{ts}{Rito \times Cp}} - {e}^{- \frac{ts}{Rito \times ( Cp + Cf )}} ) \qquad ( 1 )$$

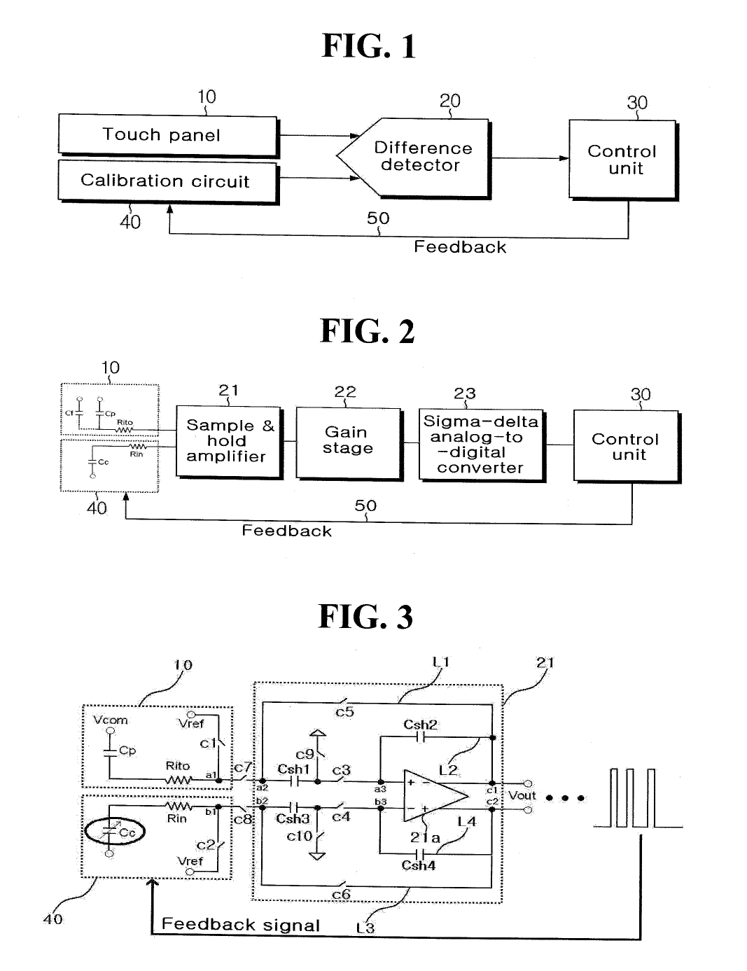

Equation 1 will be described with reference to example FIGS. 2 and 3. Example FIG. 2 illustrates a block diagram of a capacitance-type touch sensing apparatus in accordance with embodiments of the invention, showing the difference detector 20 in example FIG. 1.

As illustrated in example FIG. 2, the difference detector 20 includes an amplifying unit and a converting unit for detecting the difference of the voltages applied thereto from one channel of the touch panel 10 which is one of the two input terminals and from the calibration circuit 40. For example, the amplifying unit has a sample & hold amplifier 21 and a gain stage 22. Moreover, the converting unit has a sigma-delta analog-to-digital converter 23.

The touch panel 10 which is one of the two input terminals of the sample & hold amplifier 21 has two capacitors Cp and Cf charged by the supply voltage Vref and takes an output voltage coming from charges discharged from the two capacitors Cp and Cf as one input voltage. The resistor Rito can be a parasitic component of the touch panel 10. A time constant charged to the capacitor in a case the touch is made to the touch panel 10 is greater than the time constant charged to the capacitor in a case no touch is made to the touch panel 10.

The time constant charged to the capacitor in the case no touch is made to the touch panel 10 is determined by one capacitor Cp and one resistor Rito. The time constant charged to the capacitor in the case the touch is made to the touch panel 10 is determined by the capacitor Cp and an additional capacitor Cf, making the time constant greater. A greater time constant means a longer charging time period.

The calibration circuit 40 which is one of the two input terminals to the sample & hold amplifier 21 has a capacitor Cc charged by the supply voltage Vref, and a resistor Rin which forms a RC network with the capacitor Cc. At least one of the capacitor Cc and the resistor Rin has a variable structure. The sample & hold amplifier 21 samples the first and second voltages applied thereto from the two input terminals and detects a difference of the two voltages. In this instance, as described before, the two input terminals matched to the output terminal of the touch panel 10 and the output terminal of the calibration circuit 40.

The gain stage 22 amplifies a signal from the sample & hold amplifier 21. It is preferable that the gain stage 22 is provided with a filter for removing noise components from the signal amplified. The sigma-delta analog-to-digital converter 23 converts the signal from the gain stage 22 to a digital signal. The control unit 30 interprets the digital signal from the sigma-delta analog-to-digital converter 23. Then, according to a result of the interpretation, the control unit 30 provides a control signal to the calibration circuit 40 through the feedback routine 50 for adjusting impedance of the calibration circuit 40 or determines whether a touch is made to the touch panel 10 or not and touch sensitivity.

The apparatus in accordance with embodiments of the invention is operative to make a voltage (hereafter, a first input voltage) from the charge charged at one Cp of the two capacitors in the touch panel 10, and a voltage (hereafter, a second voltage) from the charge charged at the capacitor Cc in the calibration circuit 40 the same or a difference of the first input voltage and the second input voltage minimum. Even in a case no touch is made to the touch panel 10, the difference of the two voltages can take place by other factors. In the calibration mode, the difference of the two input voltages taken place by a certain factor is detected, and stored as an error code, and the impedance of the calibration circuit is calibrated. In the scan mode, the control unit 30 determines whether the touch is made to the touch panel 10 or not and the touch sensitivity with reference to the difference of the two input voltages while referring to the error codes stored.

Particularly, in the scan mode, the control unit 30 determines whether the touch is made to the touch panel 10 or not and the touch sensitivity with reference to the difference of the two input voltages having an extent of difference as much as the error codes stored in the calibration mode subtracted therefrom. That is, the control unit 30 is in a state in which control unit 30 processes as much as the difference of the two input voltages in advance and stores the same therein as the error code at the time of the calibration mode. The control unit 30 processes only the difference of the two input voltages excluding as much as the error code to determine whether the touch is made to the touch panel 10 or not and the touch sensitivity in the scan mode. A processing load of the control unit 30 for processing the difference between the two input voltages, therefore, can be reduced in the scan mode.

For example, the control unit 30 stores error codes different from one another for each channel in the calibration mode. Of course, since the difference of the two input voltages can be the same between any two channels, the same error codes can be stored for the two channels. In the scan mode, therefore, if it is the case no touch is made to the touch panel 10, the control unit 30 can determine that no touch is made to the touch panel 10 even if the difference between two input voltages exists. This is due to the control unit 30 knowing in advance that no touch is made to the touch panel 10 due to the stored error code.

In the calibration mode, the control unit 30 provides the control signal to the calibration circuit 40 such that the second input voltage becomes the same with the first input voltage or the difference between the two input voltages becomes minimum, for changing the impedance of the calibration circuit 40. For an example, the calibration circuit 40 has a variable capacitor with one fixed resistor and a plurality of capacitors. The control unit 30 provides the control signal to the calibration circuit 40 such that the difference between the first input voltage and the second input voltage becomes minimum, or the difference between the two input voltages becomes the same, for the calibration circuit 40 to search for a pertinent capacitor by binary search according to the control signal.

A calibration process in the calibration mode is an operation of providing the control signal to the calibration circuit 40 for a plurality of times. For example, the control unit 30 provides the control signal to the calibration circuit 40 for eight times in total for adjusting the impedance of the calibration circuit 40. If the input voltage is calibrated accurately in the calibration mode, the difference detected at the sample & hold amplifier 21 becomes a minimum level or 0 level, when the control unit 30 finishes operation of the calibration mode. Since the impedance of the calibration circuit 40 is adjusted in the calibration mode, the second input voltage is adjusted to a calibrated voltage (hereafter, a third input voltage), the third input voltage is the same, or has a minimum difference from the first input voltage.

If the touch to the touch panel 10 is taken place in the scan mode, the time constant charged to the capacitor becomes greater. According to this, a voltage (hereafter, a fourth input voltage) is generated by the charge charged in the capacitors Cp and Cf in the touch panel 10. If the touch to the touch panel 10 is taken place in the scan mode, the third input voltage and the fourth input voltage are applied to the two input terminals of the sample & hold amplifier 21.

The sample & hold amplifier 21 samples the two input voltages and detects a voltage difference between a case no touch is taken place to the touch panel 10 and a case a touch is taken place to the touch panel 10. In this instance, the voltage difference can be expressed as Equation 1 described hereinabove. For example, the voltage difference is a few mV level. The gain stage 22 increases an output level of the sample & hold amplifier 21. In this instance, a filter in rear of the gain stage 22 removes or attenuates a noise component from an amplified output. The sigma-delta analog-to-digital converter 23 converts the signal having the noise component removed or attenuated thus into a digital signal.

The control unit 30 counts a number of pulses of the digital signal from the sigma-delta analog-to-digital converter 23, to determine whether a touch to the touch panel 10 is made or not and touch sensitivity. For example, if it is assumed that the number of pulses on the difference taken place in the calibration mode is n, the control unit 30 takes as many as the number of the pulses as the error and stores an error code corresponding thereto. Upon reception of the pulse on the difference taken place in the scan mode, the control unit 30 determines that the touch is made to the touch panel 10. Moreover, the control unit 30 counts the number of received pulses to determine the touch sensitivity of the touch panel 10 with a result in which a number of pulses corresponding to the error code is subtracted from the number of counted pulses. A configuration and operation of the sample & hold amplifier 21 will be described with reference to example FIG. 3.

Example FIG. 3 illustrates a circuit diagram of a capacitance-type touch sensing apparatus in accordance with embodiments of the invention partially, showing details of the two input terminals and the sample & hold amplifier 21. Example FIG. 3 also illustrates an example in which the calibration circuit 40 has a fixed resistor Rin and a variable capacitor Cc for adjusting the impedance thereof. Example FIG. 3 is also provided for describing operation of the two input terminals and the sample & hold amplifier 21 in the calibration mode.

The sample & hold amplifier 21 of the apparatus in accordance with embodiments of the invention has two input terminals: one input terminal is the touch panel 10, and the other input terminal is the calibration circuit 40. Since a configuration of the two input terminals is described with reference to example FIGS. 1 and 2, the same will be omitted, and since example FIG. 3 is provided for describing the calibration mode, the capacitor Cf provided to the touch panel 10 is omitted. The sample & hold amplifier 21 has a plurality of capacitors Csh1, Csh2, Csh3, and Csh4 and an amplifier 21a for providing the difference between the two inputs. The first capacitor Csh1 and the third capacitor Csh3 are provided for having charges corresponding to the input voltages applied to the two input terminals charged thereto respectively. The second capacitor Csh2 and the fourth capacitor Csh4 are provided for having the charges charged to the first capacitor Csh1 and the third capacitor Csh3 applied and charged thereto, respectively. That is, the second capacitor Csh2 and the fourth capacitor Csh4 have the charges from the first capacitor Csh1 and the third capacitor Csh3 charged thereto, respectively.

As first to eighth switches c1˜c8 are switched, charging and discharging of the two input terminals and the capacitors Csh1, Csh2, Csh3, and Csh4 in the sample & hold amplifier 21 take place. The first switch c1 and the second switch c2 respectively provided to the touch panel 10 and the calibration circuit 40 are switched for applying the supply voltage Vref to the touch panel 10 and the calibration circuit 40, respectively. The first to sixth switches c1˜c6 are switched at the same timing, and the seventh to tenth switches c7˜c10 are switched at the same timing while the first to sixth switches c1˜c6 are switched opposite to the seventh to tenth switches c7˜c10. That is, at the time the first to sixth switches c1˜c6 are switched on, the seventh to tenth switches c7˜c10 are switched off, and vice versa.

The capacitor Csh1 is connected to the first input terminal which is the touch panel 10, and the capacitor Csh3 is connected to the second input terminal which is the calibration circuit 40. When the first to sixth switches c1˜c6 are switched on, charges are charged to the capacitor Cp of the touch panel 10 and the capacitor Cc of the calibration circuit 40. In this instance, if the first capacitor Csh1 and the third capacitor Csh3 have the charges charged therein, the charged charges are discharged to charge the second capacitor Csh2 and the fourth capacitor Csh4, respectively.

Then, if the seventh to tenth switches c7˜c10 are switched on at the same time with switching off of the first to sixth switches c1˜c6, the charge in the capacitor Cp of the touch panel 10 is discharged to the first capacitor Csh1, and the charge in the capacitor Cc of the calibration circuit 40 is discharged to the third capacitor Csh3. In this instance, the charges in the second capacitor Csh2, and the fourth capacitor Csh4 are forwarded to the output terminal of the sample & hold amplifier 21 for the amplifier 21a to output a voltage difference Vout.

Then, when the seventh to tenth switches c7˜c10 are switched off at the same time with switching on of the first to sixth switches c1˜c6, while charges are charged to the capacitor Cp of the touch panel 10 and the capacitor Cc of the calibration circuit 40, the charges in the first capacitor Csh1 and the third capacitor Csh3 are discharged to the second capacitor Csh2 and the fourth capacitor Csh4, respectively. Thus, following alternative switching of the first to sixth switches c1˜c6 and the seventh to tenth switches c7˜c10, the charges in the capacitor Cp of the touch panel 10 and the capacitor Cc of the calibration circuit 40 are forwarded to the output terminal of the sample & hold amplifier 21 through the first to fourth capacitors Csh1˜Csh4 for the sample & hold amplifier 21 to output the difference Vout of the two input voltages.

In the calibration mode, upon reception of the control signal (i.e., the feedback signal) on the difference from the amplifier 21a, the calibration circuit 40 adjusts the capacitance of the capacitor Cc. In this instance, since a method for adjusting the capacitance of the capacitor Cc is described before, detailed description thereof will be omitted. In the meantime, as the capacitance of the calibration circuit 40 is changed according to the control signal received thus, a voltage at a fifth node b1 becomes the same with, or similar to, a voltage at the first node a1.

An inside configuration of the sample & hold amplifier 21 will be described. Furthermore, in order to make the description easy, an output node of the touch panel 10 is defined as a first node a1, an output node of the calibration circuit 40 is defined as a fifth node b1, one input node of the two inputs of the sample & hold amplifier 21 having a potential the same with the first node a1 is defined as a second node a2, and the other one input node of the two inputs of the sample & hold amplifier 21 having a potential the same with the fifth node b1 is defined as a sixth node b2.

Moreover, one input node of the two inputs of the amplifier 21a in the sample & hold amplifier 21 is defined as a third node a3, the other input node of the two inputs of the amplifier 21a is defined as a seventh node b3, and one output node of the two outputs of the amplifier 21a is defined as a fourth node c1 and the other one output node of the two outputs of the amplifier 21a is defined as an eighth node c2.

The amplifier 21a has two electric connection lines of first and second lines L1 and L2 which connect the fourth node c1 which is one output node to one of the two input sides in parallel, and another two electric connection lines of third and fourth lines L3 and L4 which connect the eighth node c2 which is one output node to the other one of two input sides in parallel. Particularly, a configuration between one of the two input sides and the output side of the amplifier 21a is identical to a configuration between the other one of the two input sides and the output side of the amplifier 21a.

The configuration between one of the two input sides and the output side of the amplifier 21a has the electric connection line of the first line L1 connected between the second node a2 which is the input side node of the amplifier 21a and the fourth node c1 which is the output node of the amplifier 21a, and the electric connection line of the second line L2 connected between the third node a3 which is the input side node of the amplifier 21a and the fourth node c1 which is the output node of the amplifier 21a. Furthermore, the first capacitor Csh1 is provided between the second node a2 and the third node a3 which are the input side nodes of the amplifier 21a, the fifth switch c5 is provided to the first line L1, the second capacitor Csh2 is provided to the second line L2, and the third switch c3 is provided between the first capacitor Csh1 and the third node a3 which is the input side node. A ground terminal having the ninth switch c9 is connected to the first capacitor Csh1 and the third switch c3 in parallel.

The configuration between the other one of the two input sides and the output side of the amplifier 21a has the electric connection line of the third line L3 connected between the sixth node b2 which is the input side node of the amplifier 21a and the eighth node c2 which is the other output node of the amplifier 21a, and the electric connection line of the second line L4 connected between the seventh node b3 which is the input side node of the amplifier 21a and the eighth node c2 which is the output node of the amplifier 21a. Furthermore, the third capacitor Csh3 is provided between the sixth node b2 and the seventh node b3 which are the input side nodes of the amplifier 21a, the sixth switch c6 is provided to the third line L3, the fourth capacitor Csh4 is provided to the fourth line L4, and the fourth switch c4 is provided between the third capacitor Csh3 and the seventh node b3 which is the input side node. A ground terminal having the tenth switch c10 is connected to the third capacitor Csh3 and the fourth switch c4 in parallel.

The seventh switch c7 is provided between the first node a1 which is the output node of the touch panel 10 and the second node a2 which is one of the input nodes of the sample & hold amplifier 21 for applying the charge from the capacitor Cp of the touch panel 10 to the second node a2 which is one of the two inputs of the sample & hold amplifier 21. The eighth switch c8 is provided between the fifth node b1 which is the output node of the calibration circuit 40 and the sixth node b2 which is the other one of the input nodes of the sample & hold amplifier 21 for applying the charge from the capacitor Cc of the calibration circuit 40 to the sixth node b2 which is the other one of the input nodes of the sample & hold amplifier 21.

By providing the feedback routine and the calibration circuit for calibrating error which are liable to take place by different factors in advance in the calibration mode, the apparatus for sensing a touch of the apparatus in accordance with embodiments of the invention can minimize a mismatch error which is liable to take place in a calibration process or offset which is liable to take place due to a circuit or an external environment, permitting to detect the touch to the touch panel more accurately and improve the touch sensitivity of the touch panel in the scan mode.

Although embodiments have been described, it should be understood that numerous other modifications and embodiments can be devised by those skilled in the art that fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the components parts and/or arrangements, alternative uses will also be apparent to those skilled in the art.

What is claimed is:

1. An apparatus for sensing a touch comprising:
a first amplifier having a first input terminal and a second input terminal configured to output a difference of a first input voltage applied to the first input terminal and a second input voltage applied to the second input terminal;
a second amplifier configured to amplify and output the difference from the first amplifier;
a converting unit configured to convert the output from the second amplifier into a digital signal and output the digital signal; and
a control unit configured to interpret the output from the converting unit and thereby output a control signal which adjusts impedance of the second input terminal,
wherein the control unit is also configured to store the output from the converting unit as an error code in a calibration mode, and detect a change of a voltage applied to the first input terminal from a result of comparing the output from the converting unit with reference to the error code stored in a scan mode.

2. The apparatus of claim 1, wherein:
the first input voltage corresponds to a quantity of the charge in a capacitor provided to the first input terminal; and
the second input voltage corresponds to a quantity of the charge in a capacitor provided to the second input terminal.

3. The apparatus of claim 1, wherein:
the first input terminal corresponds to one channel; and
the second input terminal corresponds to a RC network having a resistor and a capacitor in a capacitance-type touch panel.

4. The apparatus of claim 3, wherein the RC network has a structure in which at least one of the resistor and the capacitor is variable.

5. The apparatus of claim 3, wherein the RC network includes a fixed resistor, and a variable capacitor which varies capacitance in response to a feedback signal.

6. The apparatus of claim 1, wherein:
the first amplifier is a sample & hold amplifier;
the second amplifier is a gain stage; and
the converting unit is a sigma-delta analog-to-digital converter.

7. The apparatus of claim 1, further comprising a filter configured to remove a noise component from the output of the second amplifier.

8. The apparatus of claim 1, wherein the apparatus is configured for operation between the calibration mode to adjust impedance of the second input terminal and the scan mode to scan a touch and touch sensitivity at the first input terminal.

9. The apparatus of claim 8, wherein the control unit is configured to provide feedback signals to the second input terminal through a feedback routine configured to adjust impedance of the second input terminal in the calibration mode.

10. The apparatus of claim 9, wherein the control unit is configured to provide the feedback signals until the second input voltage becomes equal to the first input voltage to adjust the impedance of the second input terminal in the calibration mode.

11. The apparatus of claim 9, wherein the control unit is configured to provide the feedback signals such that a difference between the first input voltage and the second input voltage becomes minimum in the calibration mode.

12. The apparatus of claim 8, wherein the control unit is configured to determine whether or not a touch is made and also a touch sensitivity at the first input terminal with reference to a difference between a voltage applied to the first input terminal and a voltage applied to the second input terminal in the scan mode.

13. The apparatus of claim 12, wherein the control unit is configured to determine whether or not a touch is made and also the touch sensitivity at the first input terminal with reference to the error code stored in the scan mode.

14. The apparatus of claim 13, wherein the control unit is configured to count pulses corresponding to the difference between the voltage applied to the first input terminal and the voltage applied to the second input terminal to determine whether or not a touch is made and the touch sensitivity at the first input terminal

15. The apparatus of claim 14, wherein the control unit is configured to determine whether or not the touch is made and the touch sensitivity at the first input terminal as a result in which the pulses corresponding to the error code stored is subtracted from the pulses counted.

16. The apparatus of claim 1, wherein:
the first input terminal and the second input terminal are driven by a common supply voltage; and
the first input terminal and the second input terminal have switches configured to switch on the supply voltage to the first input terminal and the second input terminal, respectively.

17. The apparatus of claim 1, wherein the first amplifier comprises:
an first amplifier unit configured to output a difference between a voltage applied to the first input terminal and a voltage applied to the second input terminal;
a first line and a second line configured to connect a first node and a second node which are provided to one of input sides of the first amplifier unit to a third node provided to an output side of the first amplifier unit in parallel;
a third line and a fourth line configured to connect a fourth node and a fifth node which are provided to the other one of the input sides of the amplifier to the third node provided to an output side of the first amplifier unit in parallel;
a first capacitor provided between the first node and the second node;
a second capacitor provided between the second line which corresponds between the second node and the third node;
a third capacitor provided between the fourth node and the fifth node; and
a fourth capacitor provided on the fourth line which corresponds between the fifth node and the third node,
wherein the first node has a potential equal to a potential of the first input terminal, and the fourth node has a potential equal to the potential of the second input terminal.

18. The apparatus of claim 17, wherein:
the first amplifier comprises a second switch between the first capacitor and the second node; and
a ground terminal having a third switch configured to switch together with the first switch is connected to the first capacitor and the second switch in parallel.

19. The apparatus of claim 17, wherein the first amplifier comprises:
a fourth switch on the third line and a fifth switch between the third capacitor and the fifth node; and
a ground terminal having a sixth switch configured to switch together with the fourth switch is connected to the third capacitor and the fifth switch in parallel.

20. An apparatus for sensing a touch comprising:
a first amplifier having a first input terminal and a second input terminals configured to output a difference of a first input voltage applied to the first input terminal and a second input voltage applied to the second input terminal;
a second amplifier configured to amplify and output the difference from the first amplifier;
a converting unit configured to convert the output from the second amplifier into a digital signal and output the digital signal; and
a control unit configured to receive the digital signal from the converting unit and output a control signal which adjusts impedance of the second input terminal; and
a filter configured to remove a noise component from the output of the second amplifier,
wherein the apparatus is configured for operation between a calibration mode to adjust impedance of the second input terminal and a scan mode to scan a touch and touch sensitivity at the first input terminal, such that in the calibration mode, the control unit is configured to store the digital signal from the converting unit as an error code, and in the scan mode, the control unit is configured to detect a change of a voltage applied to the first input terminal from a result of comparing the output from the converting unit with reference to the error code stored in the scan mode.
